(19) United States
(12) Patent Application Publication
(10) Pub. No.: US 2018/0001314 A1
(43) Pub. Date: Jan. 4, 2018

(54) CHROMATOGRAPHY MEDIA AND ION EXCHANGE RESIN PERFORMANCE RESTORATION

(71) Applicant: Evoqua Water Technologies LLC, Lowell, MA (US)

(72) Inventors: Marty Wilkes, Roscoe, IL (US); Gregory Bachman, Loves Park, IL (US)

(21) Appl. No.: 15/544,271

(22) PCT Filed: Jan. 20, 2016
(86) PCT No.: PCT/US2016/014048

§ 371 Date: Jul. 18, 2017

Related U.S. Application Data
(60) Provisional application No. 62/106,320, filed on Jan. 22, 2015.
(60) Provisional application No. 62/200,806, filed on Aug. 4, 2015.

(51) Int. Cl. B01J 49/53; B01D 15/20; B01J 49/57; C11D 3/386; B01J 49/60

(52) U.S. Cl. CPC B01J 49/53; C11D 3/38618; B01J 49/60; B01J 49/57; B01D 15/203

(57) ABSTRACT

An ion exchange resin rejuvenation system includes a vessel, a source of a first cleaning solution including an enzyme fluidly connected to the vessel, a source of a second cleaning solution fluidly connected to the vessel, a source of rinse solution connected to the vessel, and a source of a resin regeneration solution fluidly connected to the vessel.

### RELATED APPLICATIONS

This application claims priority under 35 U.S.C. §119(e) to U.S. Provisional Application Ser. No. 62/106,320 titled “Method for Chromatography Media and Ion Exchange Resin Performance Restoration” filed on Jan. 22, 2015, and to U.S. Provisional Application Ser. No. 62/200,806 titled “Method for Chromatography Media and Ion Exchange Resin Performance Restoration” filed on Aug. 4, 2015, which are herein incorporated by reference in their entireties.

### FIELD OF TECHNOLOGY

Aspects and embodiments disclosed herein relate to treatment of ion exchange resin, and more particularly, to treatment of ion exchange resin to clean and regenerate the ion exchange resin.

### SUMMARY

In accordance with an aspect, there is provided an ion exchange resin rejuvenation system. The ion exchange resin regeneration system comprises a vessel, a source of a first cleaning solution including an enzyme fluidly connected to the vessel, a source of a second cleaning solution fluidly connected to the vessel, a source of rinse solution fluidly connected to the vessel, and a source of a resin regeneration solution fluidly connected to the vessel.

In some embodiments, the ion exchange resin regeneration system further comprises a source of ion exchange resin contaminated with a protein layer and/or an oil layer. In some embodiments, the protein layer comprises keratin.

In some embodiments, first cleaning solution further comprises a non-ionic surfactant. In some embodiments, the enzyme is a protease. In some embodiments, the enzyme is subtilisin.

In some embodiments, the contaminated ion exchange resin comprises anion exchange resin. In some aspects, the second cleaning solution comprises a caustic solution. In some embodiments, the second cleaning solution further comprises a brine solution.

In some embodiments, the ion exchange resin is a gel type ion exchange resin.

In some embodiments, the ion exchange resin is a macroporous ion exchange resin.

In some embodiments, the ion exchange resin comprises cation exchange resin. In some embodiments, the second cleaning solution comprises a caustic solution.

In accordance with some aspects, there is provided a method of regenerating ion exchange resin. The method comprises treating an ion exchange resin contaminated with a protein layer with a first cleaning solution including an enzyme to provide a stripped ion exchange resin and protein fragments.

In some embodiments, treating the ion exchange resin with the first cleaning solution includes treating the ion exchange resin with a protease. In some embodiments, treating the ion exchange resin with the first cleaning solution includes treating the ion exchange resin with subtilisin.

In some embodiments, treating the ion exchange resin with the first cleaning solution includes treating the ion exchange resin with the first cleaning solution at a temperature of about 55° C.

In some embodiments, treating the ion exchange resin with the first cleaning solution includes treating the ion exchange resin with the first cleaning solution at a pH of about 9.

In some embodiments, the method further comprises backwashing the protein fragments.

In some embodiments, the method further comprises treating the stripped ion exchange resin with a second cleaning solution to provide a cleaned ion exchange resin. In some embodiments, treating the stripped ion exchange resin with the second cleaning solution comprises treating the stripped ion exchange resin with an acid. In some embodiments, treating the stripped ion exchange resin with the second cleaning solution includes treating the stripped ion exchange resin with at least one of a caustic solution, a base solution, a brine solution, or a mixture thereof. In some embodiments, the method further comprises rinsing the cleaned ion exchange resin to provide a rinsed ion exchange resin. In some embodiments, rinsing the cleaned ion exchange resin comprises rinsing the cleaned ion exchange resin with deionized water. In some embodiments, rinsing the cleaned ion exchange resin comprises rinsing the cleaned ion exchange resin with an acid. In some embodiments, the method further comprises exposing the rinsed ion exchange resin to an ionic solution to produce a regenerated ion exchange resin. In some embodiments, exposing the rinsed ion exchange resin to an ionic solution comprises exposing the rinsed ion exchange resin to an acid. In some embodiments, exposing the rinsed ion exchange resin to an ionic solution comprises exposing the rinsed ion exchange resin to a base.

In some embodiments, treating the ion exchange resin comprises treating anion exchange resin.

In some embodiments, treating the ion exchange resin comprises treating cation exchange resin.

In some embodiments, treating the ion exchange resin comprises treating a gel type ion exchange resin.

In some embodiments, treating the ion exchange resin comprises treating a macroporous ion exchange resin.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a schematic diagram of a contaminated ion exchange resin;

FIG. 2 is a schematic diagram of a system for rejuvenating ion exchange resin;

FIG. 3 is a block diagram of a method for rejuvenating ion exchange resin;

FIG. 4 is a block diagram of a computer system upon which embodiments of a method for rejuvenating ion exchange resins may be performed; and

FIG. 5 is a block diagram of a memory system of the computer system of FIG. 4.

### DETAILED DESCRIPTION

Aspects and embodiments disclosed herein are not limited to the details of construction and the arrangement of components set forth in the following description or illustrated in the drawings. Aspects and embodiments disclosed herein are capable of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Aspects and embodiments disclosed herein are directed to systems and methods of treating ion exchange resins to, for example, clean and regenerate the resin for re-use. Cleaning and regenerating ion exchange resin may be referred to herein as “rejuvenating” the ion exchange resin. Cleaning the resin may include at least partially removing one or both of protein or oil from the resin. Aspects and embodiments disclosed herein relate to ion exchange resin regeneration systems and methods of operation and facilitating thereof. Aspects and embodiments disclosed herein are not limited in application to the details of construction and the arrangement of components, systems, or subsystems set forth herein, and are capable of being practiced or of being carried out in various ways.

Ion exchange is the reversible interchange of ions between a solid ion exchange resin and a liquid, in which there is no permanent change in the structure of the solid. Ion exchange resins may be used in, for example, corn sweetener, beet sweetener, lysine, ethanol, and bioenergy (for example, biodiesel) production processes. An ion exchange process may be used to remove contaminants from the products of the corn sweetener, beet sweetener, lysine, ethanol, and bioenergy production processes. These processes may contaminate the ion exchange resins with contaminants including proteins, oils, and salts, for example, calcium salts and magnesium salts. Previously, ion exchange resins used in these processes could not be regenerated, and were instead discarded in landfills or incinerated, creating waste and a shortage of resins. It is also expensive to discard ion exchange resins and to purchase new resins. Rejuvenating the existing resins rather than purchasing new resins may at least partially alleviate these disadvantages of the prior art and may reduce the use of petroleum products and water that are required for the production of ion exchange resins.

Some ion exchange resins include a crosslinked polystyrene matrix. Ion exchange sites are introduced to the matrix after polymerization. The crosslinked polymer matrix typically has a relatively uniform distribution of ion exchange sites throughout the structure. Ion exchange resins may be anion exchange resins or cation exchange resins. Anion exchange resins have a positively charged matrix structure that attracts and adsorbs negatively charged ions or molecules and releases positively charged ions or molecules. Cation exchange resins have a negatively charged matrix structure that attracts and adsorbs positively charged ions or molecules and releases negatively charged ions or molecules.

The adsorption of the ions or molecules to the ion exchange resin is driven by the ionic interaction between the oppositely charged ions or ionic groups in the sample molecule and in the functional groups of the resin. The strength of the interaction is determined by the charge of the ion or number and location of the charges on the molecule to be adsorbed and on the number and location of the charges on the functional groups. Functional groups determine the four main types of ion exchange resins. The four main types of ion exchange resins are strongly acidic, strongly basic, weakly acidic, and weakly basic ion exchange resins.

Some weak acid cation exchange resins are based on acrylic or methacrylic acid that has been crosslinked with a di-functional monomer. Weak acid resins may be regenerated with strong acids. The acid-regenerated resin exhibits a high capacity for alkaline earth metals and more limited capacity for the alkali metals.

Weak base anion exchange resins do not contain exchangeable ionic sites and function as acid adsorbers. These resins are capable of sorbing strong acids with a high capacity and are readily regenerated with a caustic solution. They are particularly effective when used in combination with a strong base anion exchange resin because the combination provides an overall high operating capacity and regeneration efficiency. In some embodiments, a weak base anion exchange resin may be used upstream of a strong base anion exchange resin. In some embodiments, the combination of weak base anion exchange resin and strong base anion exchange resin may be a mixture of weak base anion exchange resins and strong base anion exchange resins. A mixture of strong base anion exchange resin and weak base anion exchange resin may be used in, for example, salt splitting. One example of salt splitting is the process of decomposing the salts of carboxylic acids into their corresponding acid and base compounds.

Strong base anion resins are classed as Type 1 and Type 2. Type 1 is a quaternized amine product made by the reaction of a trialkylamine, for example, trimethylamine with a copolymer after chloromethylation. The Type 1 functional group is the most strongly basic functional group available and has the greatest affinity for weak acids, for example, silicic acid and carbonic acid, that are present during some water demineralization processes. However, the efficiency of regeneration of the resin to the hydroxide form is somewhat lower, particularly when the resin is exhausted with monovalent anions, such as chloride and nitrate. The regeneration efficiency of a Type 2 resin is considerably greater than that of Type 1. Type 2 functionality is obtained by the reaction of styrene-DVB copolymer with dimethylethanolamine This quaternary amine has lower basicity than that of the Type 1 resin, yet it is high enough to remove the weak acid anions for most applications. The chemical stability of the Type 2 resins is not as good as that of the Type 1 resins, the Type 1 resins being favored for high temperature applications.

In an embodiment, the ion exchange resin comprises chromatographic resins of various cross-linkage. In some embodiments, the ion exchange resin comprises quaternary styrene divinylbenze copolymer resins, for example, quaternary amine styrene divinylbenzene copolymers with uniform fine mesh particle size. In some embodiments, the ion exchange resin comprises anion exchange resin. For example, the anion exchange resin may be any commercially available anion exchange resin.

In alternative embodiments, the ion exchange resin comprises cation exchange resin. For example, the cation exchange resin may be any commercially available cation exchange resin.

Ion exchange resins may become contaminated after use. The contamination may reduce the ion exchange capacity of the ion exchange resin and/or render the ion exchange resin less capable or even incapable of being regenerated utilizing previously known methods. Such contamination is observed in, for example, ion exchange resin used to remove contaminants from the products of corn sweetener, beet sweetener, lysine, ethanol, and bioenergy production processes. The typical cleaning process for ion exchange resins used in, for example, lysine production, involves treating the ion exchange resins with ammonia to remove the lysine from the resins. The contaminants crystalize, and the ammonia may be distilled and re-used. However, it was found that after two years of use, the capacity of anion exchange resins treated in this manner may be reduced by about 25%, suggesting that other contaminants may be present on the resins.

It was discovered that treating the contaminated ion exchange resin with an enzyme and/or non-ionic surfactant may remove sufficient contamination to render the resin capable of being regenerated and reused. Without being bound to a particular theory, it is believed that in certain implementations, for example, in the aforementioned corn sweetener, beet sweetener, lysine, ethanol, and bioenergy production processes, the ion exchange resin may become contaminated with proteins and/or oils present in the products being purified by the ion exchange resin. The protein and/or oil layers may block regeneration solution from reaching the ion exchange sites on the ion exchange resin, thus making it difficult or impossible to regenerate the resin with known regeneration solutions.

Analysis of contaminated resin showed that the resin included previously unknown micro-pores, or “ink bottle” pores, that may become blocked by proteins, oils, or other organic or non-organic contaminants. In some embodiments, the micro-pores may be less than about 1 μm in diameter. For example, the micro-pores may be less than about 0.5 μm in diameter. Without being bound to a particular theory, it is believed that the blockage of the micro-pores by the contaminant(s) blocks regeneration solution from reaching ion exchange sites within the micro-pores. It was discovered that an enzyme, for example, a protease, may be utilized to remove protein or a protein layer from ion exchange resin contaminated with protein, and the non-ionic surfactant may be utilized to remove oil from ion exchange resin coated with oil. Depending on the particular product an ion exchange resin may be used to treat, there may be over 300 proteins that may contaminate the ion exchange resin. Protein detection tests may be used to determine the specific protein or proteins that are deposited on the resins so that a proper enzyme or enzymes may be used to remove it or them.

In some embodiments, contaminants may attach to ion exchange resins from a producing organism itself. For example, contaminants from a sugar producing organism may attach to ion exchange resins. In some embodiments, contaminants from corn or beets may attach to ion exchange resins.

In some implementations, proteins from the keratin family may be deposited on ion exchange resins and hinder regeneration of the ion exchange resins. Keratin is a family of fibrous structural proteins that protects epithelial cells from damage or stress. Keratin, which is included in human skin cells, may be deposited on ion exchange resins in processes that involve direct human contact with the product and/or starting materials and/or equipment used to produce the product treated by the ion exchange resin. For example, keratin may be deposited on ion exchange resins in corn and beet sweetener production processes, where humans may inadvertently directly contact the corn or beets during harvesting. Human contact with the product and/or starting materials and/or equipment used to produce the product treated by the ion exchange resin may occur at any step of the process during which humans are involved, and may be more likely when humans are not wearing gloves.

Other proteins that may contaminate ion exchange resins may include animal and plant proteins, such as weed and wheat proteins. Exemplary proteins that may contaminate ion exchange resins include ribosomal proteins, chaperonins, DNA-binding proteins, porin proteins, and flagellin. In some processes, for example, those utilizing corn as a starting material, frogs or toads may be present in silos used to store the corn and contaminate the corn with frog or toad protein, which may make its way through the process and contaminate ion exchange resin used to treat a product of the process. Even small concentrations of proteins can negatively impact the adsorptive capacity and/or the ability for regeneration of ion exchange resin. A contaminated ion exchange resin may pass the contaminants on to the product the ion exchange resin was intended to treat. For example, the contaminating proteins may be transferred to the food supply (e.g., corn or beet sweetener or animal feed produced using lysine), vitamins, and medications.

Testing by, for example, high performance liquid chromatography (HPLC) may determine the total content of proteins that contaminate the ion exchange resins. HPLC is a technique used to separate, identify, and quantify each component in a mixture. In some embodiments, a contaminated ion exchange resin may be treated with an acid, for example, hydrochloric acid (HCl). The acid digests proteins and amino acids, separating them from the ion exchange resin so that the total protein content can be determined.

The HPLC procedure may be followed by a protein electrophoresis process. The protein electrophoresis process may be used to identify the specific proteins contaminating the ion exchange resins. Protein electrophoresis is a method for analyzing the proteins in a fluid or an extract. The process determines the crude molecular weight of the proteins, which can be compared with a protein database.

Other contaminating agents may be associated with the above-described contaminants. In some embodiments, the contaminants may include bacteria. For example, the bacteria may comprise Corynebacterium glutamicum. Cornyebacterium glutamicum is a bacteria used to produce lysine. It may be a pathogen to, for example, humans, pets, and other animals, and is therefore important to remove.

In some examples, the contaminating agents may be a part of the contaminants or may connect the contaminants to each other or to the resin. In some embodiments, the protein contaminants may be attached to the resin by a contaminating agent, for example, a tethering agent. A tethering agent may be any species that links a contaminant to the resin. A tethering agent may allow an ion to attach to its opposite ion exchange resin, which cannot happen in the absence of the tethering agent. For example, a tethering agent may allow an anion to attach to a cation exchange resin. The tethering agent may be, for example, serine, glycolic acid, malic acid, oxalic acid, and calcium maleate.

A tethering agent may directly connect to the active sites of the ion exchange resin. In some embodiments, a tethering agent may connect a protein contaminant to an active site of an ion exchange resin. Testing by, for example, ion chromatography-mass spectrometry, can confirm the presence of a tethering agent. The tethering agent may be removed by one of a first cleaning solution, a second cleaning solution, or a rinse solution, depending on the specific tethering agent present.

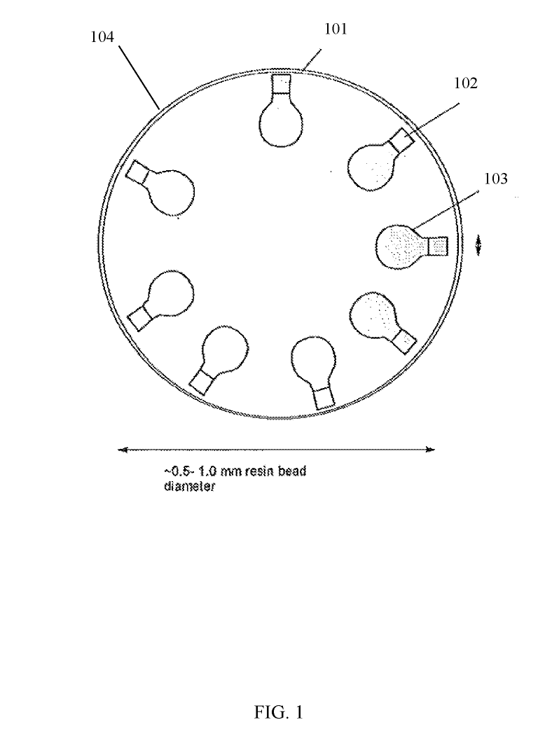

It has been determined that when resins are contaminated with a protein layer, as shown in FIG. 1, the ion exchange resins may be regenerated. Ion exchange resin 100 may be any ion exchange resin that has been contaminated in an ion exchange process. Ion exchange resin 100 may be an anion exchange resin or a cation exchange resin. Ion exchange resin 100 may be a strong acid resin, a weak acid resin, a strong base resin, or a weak base resin. Ion exchange resin 100 may comprise Type 1 resin or Type 2 resin.

Contaminated ion exchange resin 100 may comprise a protein layer 101 and/or an impurity layer 102 inhibiting access to ion exchange micropore sites 103. Impurity layer 102 may comprise contaminating molecules separate from protein layer 101. Contaminants in impurity layer 102 may comprise any molecule that may decrease the capacity of the ion exchange resin. For example, impurity layer 102 may comprise malic acid, oxalic acid, calcium oxalate, acetates, formates, and glycolates. These impurities are insoluble, and therefore block the regeneration of the resins. The presence of protein layer 101 in contaminated ion exchange resin from certain processes and the presence of ion exchange micropore sites 103 in ion exchange resin were previously unknown. Ion exchange resins including protein layer 101 and ion exchange micropore sites 103 could not previously be regenerated utilizing known methods.

In some embodiments, contaminated ion exchange resin 100 may comprise an oil layer 104. Oil layer 104 may be the outer contaminating layer. Oils that may be deposited on the ion exchange resin may include plant oils, for example, coconut oil. Coconut oil may be deposited on the ion exchange resin from a media ingredient that has not been fully metabolized. For example, coconut oil may be deposited on ion exchange resin from a fermentation media ingredient for Corynebacterium. In some embodiments, the oil layer 104 may comprise bacterial lipids or lipids from human skin. In some embodiments, the oils may be other oils from human sources. For example, the oil layer 104 may be squalene.

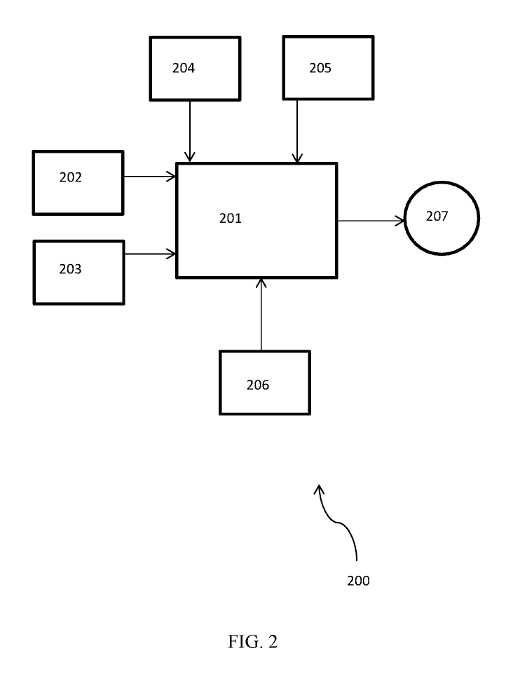

Regeneration of ion exchange resins is a reversal of the ion exchange processes described above. Referring to FIG. 2, rejuvenation of ion exchange resins may take place in an ion exchange resin rejuvenation system 200. In some embodiments, the ion exchange resin rejuvenation system 200 may be included in a system in which the ion exchange resin is used to treat a product and regeneration of the ion exchange resin may be performed in situ. In other embodiments, the ion exchange resin rejuvenation system 200 may be a system separate from a system in which the ion exchange resin is used to treat a product and the ion exchange regeneration process may be performed ex situ. The ion exchange rejuvenation system 200 may comprise a vessel 201. Ion exchange resin rejuvenation system 200 may further comprise a source of ion exchange resin 202, fluidly connected to the vessel. Source of ion exchange resin 202 may comprise anion exchange media or cation exchange media that has been contaminated with protein or a protein layer. In some embodiments, the protein layer 101 comprises keratin. In some embodiments, the protein layer 101 comprises Cornybacterium glutamicum 50S ribosomal protein.

Ion exchange rejuvenation system 200 may further comprise a source of a first cleaning solution 203 fluidly connected to vessel 201. First cleaning solution 203 may comprise an enzyme to remove the protein layer 101. The enzyme may be any enzyme that is capable of removing a protein. The enzyme may be selected based on the contaminating protein to be removed from ion exchange resin 202. In some embodiments, the enzyme may be a protease. For example, the enzyme may be subtilisin. The pH of the first cleaning solution 203 is determined by the optimum pH for the enzyme. For example, the optimum pH of the enzyme subtilisin may be about from about 7 to about 9. For example, the optimum pH of the enzyme subtilisin may be about 7.5. When the first cleaning solution 203 comprises subtilisin, the pH of the first cleaning solution 203 may be about 7.5. First cleaning solution 203 may be added in any amount sufficient to remove the protein from ion exchange resin 202. In some embodiments, first cleaning solution 203 may be added to vessel 201 such that a 100:1 ratio of protein on ion exchange resin 202 to enzyme in first cleaning solution 203 is achieved.

In some embodiments, the ion exchange resin 202 may be contaminated with oil in addition to protein or in the absence of protein contamination. The specific contaminating oil may be dependent on the process in which the ion exchange resin 202 was used. In some embodiments, ion exchange resin 202 may be contaminated with a plant-based oil. For example, ion exchange resin 202 may be contaminated with coconut oil. In some embodiments, first cleaning solution 203 comprises a surfactant to remove the oil in addition to or as an alternative to an enzyme. In some embodiments the source of the first cleaning solution 203 may include a source of an enzyme and a source of a surfactant. The source of the surfactant may be the same or separate from the source of the enzyme.

First cleaning solution 203 may comprise any surfactant capable of removing the contaminating oil from the ion exchange resin 202. For example, the surfactant may be a non-ionic surfactant. Non-ionic surfactants may be preferable because they may not attach to, and therefore further contaminate, the ion exchange resin 202. In some embodiments, a non-ionic detergent is used. For example, the detergent may be Triton™ X-100 non-ionic surfactant (Sigma Aldrich®), sodium dodecylsulfate, or polysorbate 20, depending on the targeted oil. In some embodiments, the oil may be present as a layer over the protein or protein layer and in other embodiments, may be mixed with the protein or protein layer. The order of application of enzyme and/or surfactant to clean the ion exchange resin may be selected based on the structure of the contaminating protein and oil layers or mixture. For example, if the outer contaminating layer comprises an oil, a surfactant may be applied to the ion exchange resin first, in order to remove the oil layer and expose the inner contaminating layers. In another embodiment, if the outer contaminating layer comprises a protein, an enzyme may be applied to the ion exchange resin first, in order to remove the protein layer and expose the inner contaminating layers.

Ion exchange resin rejuvenation system 200 may further comprise a source of a second cleaning solution 204 fluidly connected to vessel 201. Source of second cleaning solution 204 may comprise a caustic solution. For example, source of second cleaning solution 204 may comprise sodium hydroxide (NaOH). In some embodiments, source of second cleaning solution 204 may further comprise a brine solution. For example, source of second cleaning solution 204 may comprise sodium chloride (NaCl) or a NaCl solution.

Ion exchange resin regeneration system 200 may further comprise a source of a rinse solution 205. In some embodiments, source of rinse solution 205 may comprise water. For example, source of rinse solution 205 may comprise deionized water. In other embodiments, source of rinse solution 205 may comprise an acid. For example, source of rinse solution 205 may comprise HCl.

Ion exchange resin rejuvenation system 200 may further comprise a source of an ion exchange resin regeneration solution 206 fluidly connected to vessel 201. In some embodiments, ion exchange resin regeneration solution 206 may comprise a caustic solution. For example, ion exchange resin regeneration solution 206 may comprise NaOH. In some embodiments, ion exchange resin regeneration solution 206 may further comprise an acidic solution. For example, ion exchange resin regeneration solution 206 may further comprise HCl and/or sulfuric acid (H₂SO₄).

Ion exchange resin rejuvenation system 200 may further comprise a regenerated ion exchange resin tank 207 fluidly connected to vessel 201. In some embodiments, regenerated ion exchange resin tank 207 may comprise a resin holding tank. In some embodiments, regenerated ion exchange resin tank 207 may be fluidly connected to a point of use (not shown).

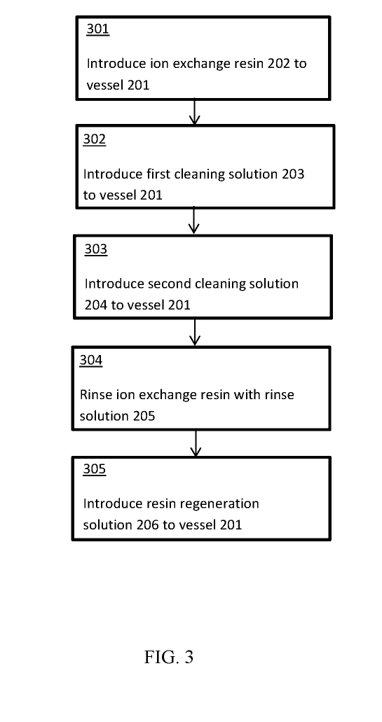

Referring now to FIG. 3, an ion exchange resin regeneration method 300 is shown. In some embodiments, ion exchange resin regeneration method 300 comprises introducing contaminated ion exchange resin 202 to vessel 201 (step 301). Ion exchange resin 202 may comprise anion exchange resin or cation exchange resin. Ion exchange resin 202 may be contaminated with protein layer 101 and/or oil or an oil layer. In some embodiments, the protein layer 101 comprises keratin.

In some embodiments, ion exchange resin regeneration method 300 further comprises introducing a source of a first cleaning solution 203 to vessel 201 (step 302) to produce stripped ion exchange resin and protein fragments. In some embodiments, the first cleaning solution 203 may be recirculated through vessel 201 for an amount of time sufficient to break down protein layer 101 and/or to remove oil from the contaminated ion exchange resin. In some embodiments, first cleaning solution 203 may be recirculated through vessel 201 for about 3 hours. In some embodiments, the first cleaning solution 203 may comprise an enzyme to remove the protein layer 101. In some embodiments, the enzyme may be a protease. For example, the enzyme may be subtilisin. In some embodiments, the first cleaning solution 203 may have a pH of between about 6 and about 11, for example, about 9. In some embodiments, the method may further comprise, prior to introduction of the first cleaning solution 203 to vessel 201, a step of warming the first cleaning solution 203 to a temperature of between about 50° C. and about 60° C., for example, about 55° C. In some embodiments, the ratio of enzyme to protein may be about 1:100 by weight.

In some embodiments, the first cleaning solution 203 may comprise a non-ionic surfactant to remove oils. Oils that may be deposited on the ion exchange resin may include plant oils, for example, coconut oil. Coconut oil may be deposited on the ion exchange resin from a media ingredient that has not been fully metabolized. For example, coconut oil may be deposited on ion exchange resin from a fermentation media ingredient for Corynebacterium. In some embodiments, the oils may be bacterial lipids or lipids from human skin. In some embodiments, the oils may be other oils from human sources. For example, the oil may be squalene. The oils may be removed with non-ionic surfactants such as Triton™ X-100 non-ionic surfactant, sodium dodecylsulfate, or polysorbate 20. A suitable surfactant may be selected based on the targeted contaminating oil.

As the protein is broken down by first cleaning solution 203, it may form a foam. In some embodiments, the foam will be removed from vessel 201 to prohibit it from contaminating the resin. In some embodiments, the foam and remaining protein fragments may be backwashed and the ion exchange resin may be rinsed with a second cleaning solution 204 to produce a cleaned ion exchange resin. Second cleaning solution 204 may be introduced to vessel 201 (step 303). In some embodiments, second cleaning solution 204 may comprise a caustic solution. For example, second cleaning solution 204 may comprise NaOH. In some aspects, the second cleaning solution may comprise NaOH in a concentration of between about 1% and about 5% by weight. In some embodiments, the second cleaning solution 204 may further comprise a salt solution. For example, second cleaning solution 204 may comprise NaCl. In some aspects, the second cleaning solution may comprise NaCl in a concentration of between about 5% to about 15%. An amount and flow rate of second cleaning solution 204 sufficient to remove impurity layer 102 may be introduced to vessel 201. In some embodiments, between about 2 bed volumes and about 5 bed volumes of second cleaning solution 204 may be introduced to vessel 201. For example, about 4 bed volumes of second cleaning solution 204 may be introduced to vessel 201. In some embodiments, second cleaning solution 204 may be introduced to vessel 201 at a flow rate of between about 0.3 gal/ft³ and about 0.5 gal/ft³. The flow rates are based on a volume of the vessel 201 or a media bed volume. For example, second cleaning solution 204 may be introduced to vessel 201 at a flow rate of about 0.45 gal/ft³. In some embodiments, the second cleaning solution 204 may be recycled and reused.

Ion exchange resin regeneration method 300 may further comprise rinsing the cleaned ion exchange resin with a rinse solution 205 (step 304) to provide a rinsed ion exchange resin. In some embodiments, the rinse solution 205 may be water. For example, rinse solution 205 may be deionized water. In some embodiments, rinse solution 205 may comprise an acid. For example, rinse solution 205 may comprise HCl. Rinse solution 205 may be introduced in an amount and flow rate sufficient to remove impurity layer 102. For example, in some aspects, rinse solution 205 may be HCl in a concentration of between about 2% and about 10%. In some aspects, rinse solution 205 may be introduced to vessel 201 at a flow rate of about 1 gal/ft³ to about 1.5 gal/ft³. In some embodiments an amount of about 1 to about 4 bed volumes of rinse solution 205 may be used. In some embodiments, the ion exchange resin may be rinsed until rinse solution overflow exhibits a conductivity of less than about 3 μS. In some embodiments, rinse solution 205 may be recycled and reused.

Ion exchange resin regeneration method 300 may further comprise introducing resin regeneration solution 206 to vessel 201 (step 305). Resin regeneration solution 206 may comprise ions to repopulate ion exchange sites on the ion exchange resin, for example, in the resin micropore sites 103. Resin regeneration solution 206 may comprise a caustic solution to repopulate resin micropore sites 103 of a cation exchange resin. In some embodiments, the caustic solution may be NaOH. Resin regeneration solution 206 may further comprise an acidic solution to repopulate resin active sites 103 of an anion exchange resin. In some embodiments, the acidic solution may be HCl and/or sulfuric acid. It has been observed that the ion exchange resin can be restored to at least about 95% of its original capacity. The moisture and total capacity of the rejuvenated resins may be tested to ensure proper rejuvenation. Testing may include measuring specific parameters based on whether the ion exchange resin is a weak or a strong acid or base ion exchange resin. In some embodiments, a test may be performed to ensure that a specific contaminant has been removed. For example, a test may be performed to determine that an oil has been removed.

The rejuvenated ion exchange resin may be stored in an expanded state. For example, the rejuvenated ion exchange resin may be stored at an expanded state of approximately 40% to approximately 60% water.

Each step of ion exchange resin regeneration method 300 may be repeated. Ion exchange resin regeneration method 300 may be most effective when the contaminants are removed in the reverse order in which they were deposited on the resin.

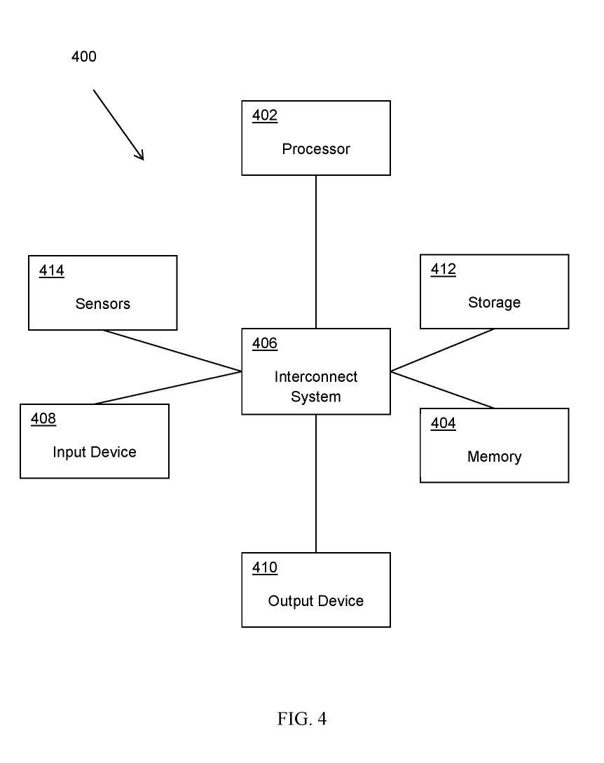

In some embodiments, a control system may be used. A controller may be used for monitoring and controlling operation of the ion exchange resin regeneration system. In some embodiments, the controller may include a computerized control system. Various aspects of the invention may be implemented as specialized software executing in a general-purpose computer system 400 such as that shown in FIG. 4. The computer system 400 may include a processor 402 connected to one or more memory devices 404, such as a disk drive, solid state memory, or other device for storing data. Memory 404 is typically used for storing programs and data during operation of the computer system 400. Components of computer system 400 may be coupled by an interconnection mechanism 406, which may include one or more busses (e.g., between components that are integrated within a same machine) and/or a network (e.g., between components that reside on separate discrete machines). The interconnection mechanism 406 enables communications (e.g., data, instructions) to be exchanged between system components of system 400. Computer system 400 also includes one or more input devices 408, for example, a keyboard, mouse, trackball, microphone, touch screen, and one or more output devices 410, for example, a printing device, display screen, and/or speaker.

The output devices 410 may also comprise valves, pumps, or switches which may be utilized to introduce a first cleaning solution, a second cleaning solution, a rinse solution, and/or a resin regeneration solution. One or more sensors 414 may also provide input to the computer system 400. These sensors may include, for example, pH sensor(s), temperature sensor(s), sensors for measuring a concentration of an undesirable component of contaminated and/or treated ion exchange resins, for example, resins contaminated with a protein, and/or other sensors useful in an ion exchange resin regeneration system. These sensors may be located in any portion of an ion exchange resin regeneration system where they would be useful, for example, upstream of a media bed and downstream of a media bed. In addition, computer system 400 may contain one or more interfaces (not shown) that connect computer system 400 to a communication network in addition or as an alternative to the interconnection mechanism 406.

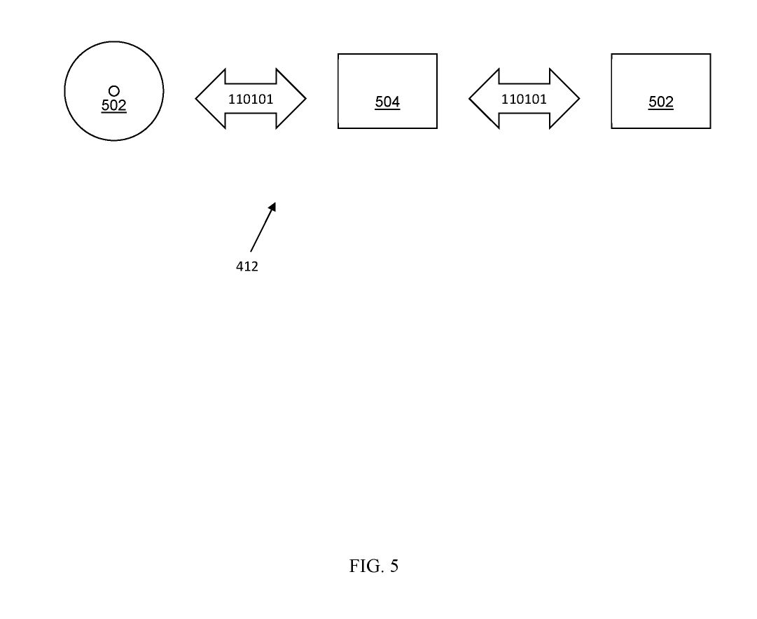

The storage system 400, shown in greater detail in FIG. 5 typically includes a computer readable and writeable nonvolatile recording medium 502 in which signals are stored that define a program to be executed by the processor or information to be processed by the program. The medium may include, for example, a disk or flash memory. Typically, in operation, the processor causes data to be read from the nonvolatile recording medium 502 into another memory 504 that allows for faster access to the information by the processor than does the medium 502. This memory 504 is typically a volatile, random access memory such as a dynamic random access memory (DRAM) or static memory (SRAM). It may be located in storage system 412, as shown, or in memory system 404. The processor 402 generally manipulates the data within the integrated circuit memory 404, 504 and then copies the data to the medium 502 after processing is completed. A variety of mechanisms are known for managing data movement between the medium 502 and the integrated circuit memory element 404, 504, and aspects and embodiments disclosed herein are not limited thereto. Aspects and embodiments disclosed herein are not limited to a particular memory system 404 or storage system 412.

The computer system may include specially-programmed, special-purpose hardware, for example, an application-specific integrated circuit (ASIC). Aspects and embodiments disclosed herein may be implemented in software, hardware or firmware, or any combination thereof. Further, such methods, acts, systems, system elements and components thereof may be implemented as part of the computer system described above or as an independent component.

Although computer system 400 is shown by way of example as one type of computer system upon which various aspects and embodiments disclosed herein may be practiced, it should be appreciated that aspects and embodiments disclosed herein are not limited to being implemented on the computer system as shown in FIG. 4. Various aspects and embodiments disclosed herein may be practiced on one or more computers having a different architecture or components than that shown in FIG. 4.

Computer system 400 may be a general-purpose computer system that is programmable using a high-level computer programming language. Computer system 400 may be also implemented using specially programmed, special purpose hardware. In computer system 400, processor 402 is typically a commercially available processor such as the well-known Pentium™ or Core™ class processors available from the Intel Corporation. Many other processors are available, including programmable logic controllers. Such a processor usually executes an operating system which may be, for example, the Windows 7, Windows 8, or Windows 10 operating system available from the Microsoft Corporation, the MAC OS System X available from Apple Computer, the Solaris Operating System available from Sun Microsystems, or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that aspects and embodiments disclosed herein are not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects and embodiments disclosed herein may be performed on a client-server system that includes components distributed among one or more server systems that perform various functions according to various aspects and embodiments disclosed herein. These components may be executable, intermediate (e.g., IL) or interpreted (e.g., Java) code which communicate over a communication network (e.g., the Internet) using a communication protocol (e.g., TCP/IP). In some embodiments one or more components of the computer system may communicate with one or more other components over a wireless network, including, for example, a cellular telephone network.

It should be appreciated that the aspects and embodiments disclosed herein are not limited to executing on any particular system or group of systems. Also, it should be appreciated that the aspects and embodiments disclosed herein are not limited to any particular distributed architecture, network, or communication protocol. Various aspects and embodiments disclosed herein are may be programmed using an object-oriented programming language, such as SmallTalk, Java, C++, Ada, or C# (C-Sharp). Other object-oriented programming languages may also be used. Alternatively, functional, scripting, and/or logical programming languages may be used, for example ladder logic. Various aspects and embodiments disclosed herein are may be implemented in a non-programmed environment (e.g., documents created in HTML, XML or other format that, when viewed in a window of a browser program, render aspects of a graphical-user interface (GUI) or perform other functions). Various aspects and embodiments disclosed herein may be implemented as programmed or non-programmed elements, or any combination thereof.

The controller may be operated under a “fuzzy logic” regime. Fuzzy logic is a problem-solving control system methodology that lends itself to implementation in systems ranging from simple, small, embedded micro-controllers to large, networked, multi-channel PC or workstation-based data acquisition and control systems. It can be implemented in hardware, software, or a combination of both. Fuzzy logic provides a way to arrive at a definite conclusion based upon vague, ambiguous, imprecise, noisy, or missing input information. A fuzzy logic approach to control problems mimics how a person would make decisions, only much faster.

### EXAMPLES

### Example 1

### Regeneration of Anion Exchange Resin

The following example is a prophetic example based on the results of a smaller scale laboratory test. To demonstrate the effectiveness of the present invention, a contaminated ion exchange resin was rejuvenated. A-499 anion exchange resins (a weak base resin available from Evoqua Water Technologies, Warrendale, Pa.) were tested for the presence of contaminants. The anion exchange resins were analyzed by a liquid chromatography/mass-spectrometry test to identify the proteins present. It was determined that the anion exchange resins were contaminated with keratin and plant proteins.

About 600 ft³ (about 17 m³) of anion exchange resin slurry comprising A-499 resin and deionized water was fed to a vessel. About 5 L of a 9% first cleaning solution comprising the enzyme subtilisin at a pH of about 9 was warmed to about 55° C. in a separate surge tank using sodium bicarbonate to adjust the pH. The warmed first cleaning solution was fed to the vessel, and about 50% of the vessel was unfilled. The warm first cleaning solution was recirculated through the vessel for about 3 hours, and was circulated for about 18 hours to allow the solution to cool to room temperature. The pH was readjusted to about 9 with sodium bicarbonate or sodium hydroxide about every half hour. It was observed that the first cleaning solution broke down the protein layer contaminating the anion exchange resin. The protein layer was broken into small peptide or amino acid pieces. It was further observed that the enzyme digested itself, so none of the subtilisin was left to contaminate processes that the regenerated resins are used in.

It was also observed that the broken down protein formed a foam layer. The foam layer was removed to prevent recontamination of the anion exchange resin. The peptide and amino acid fragments and the anion exchange resin were rinsed down with about four bed volumes of a second cleaning solution comprising 4% sodium hydroxide and 10% sodium chloride. A concentrated brown effluent was produced and disposed of as waste. Testing determined that at least 83 different anion impurities were removed by the cleaning solution. The resin was rinsed with deionized water until the overflow water exhibited a conductivity of about 3 uS.

The anion exchange resin was regenerated with an ion exchange regenerating solution comprising 10% NaOH at about 0.75 gal/ft³, followed by 10% HCl v/v at about 0.05 gal/ft³, and then by 20% HCl v/v at about 0.11 gal/ft³.

Standard anion exchange resin percent moisture and capacity testing determined that about 95% of the anion exchange resin active sites were rejuvenated, indicating the successful removal of contaminants.

### Example 2

### Regeneration of Cation Exchange Resin

The following example is a prophetic example based on the results of a smaller scale laboratory test. To demonstrate the effectiveness of the present invention, a contaminated ion exchange resin was rejuvenated. C-211 UPS strong acid cation exchange resin (available from Evoqua Water Technologies, Warrendale, Pa.) was tested for the presence of proteins using a HPLC and protein electrophoresis process. It was determined that the cation exchange resin was contaminated with a protein layer comprising Corynebacterium glutamicum 50S ribosomal protein. About 1200 ft³ (about 34 m³) of a cation exchange resin slurry comprising C-211 UPS resin and deionized water was fed to a vessel. About 213 g of a first cleaning solution comprising the enzyme subtilisin at a pH of about 9 was warmed to about 55° C. in a separate surge tank using sodium bicarbonate to adjust the pH. The warmed first cleaning solution was fed to the vessel, and about 50% of the vessel was unfilled. The warm first cleaning solution was recirculated through the vessel for about 3 hours, and was circulated for about 18 hours to allow the solution to cool to room temperature. The pH was readjusted to about 9 with sodium bicarbonate or sodium hydroxide about every half hour. It was observed that the first cleaning solution broke down the protein layer contaminating the anion exchange resin. The protein layer was broken into small peptide or amino acid pieces.

It was further observed that the enzyme digested itself, so none of the subtilisin was left to contaminate processes that the regenerated resins are used in.

It was also observed that the broken down protein formed a foam layer. The foam layer was removed to prevent recontamination of the anion exchange resin. The peptide and amino acid fragments and the anion exchange resin were rinsed down with about four bed volumes of a second cleaning solution comprising 1.5% sodium hydroxide at about 3.75 lb/ft³. A concentrated yellow brown effluent was produced and disposed of as waste. Testing determined that at least 83 different anion impurities were removed by the cleaning solution. The resin was rinsed with deionized water until the overflow water exhibited a conductivity of about 3 uS.

The resin was further rinsed with about three bed volumes of 6% HCl at about 11.24 lb/ft³. It was observed that this rinse removed calcium, potassium, and ammonium ions. The solution was adjusted to a pH of about 0.5 to remove oxalic acid.

The cation exchange resin was regenerated with an ion exchange regenerating solution comprising about two bed volumes of 1.5% NaOH at about 1.87 lb/ft³. The cation exchange resin was further rinsed with deionized water.

Standard cation exchange resin moisture percent and capacity testing determined that 95% of the cation exchange resin active sites were rejuvenated, indicating the successful removal of contaminants

### Example 3

### Presence of Tethering Agents

To determine the presence of contaminants on an ion exchange resin, and in particular, contaminants that connect other contaminants to an ion exchange resin, an ion chromatography-mass spectrometry testing was performed. More, particularly, the testing was performed to determine the presence of tethering agents on ion exchange resins. A 500 mL sample of water surrounding contaminated strong acid anion exchange resin from a lysine production process was analyzed by ion chromatography-mass spectrometry for cation analysis to determine the presence of tethering agents. It was determined that the sample of water contained a contaminating protein and calcium oxalate. Tethering agents were believed to connect impurities, including oil and proteins, to the resin. The testing identified the presence of the amino acid serine and azetidine carboxylic acid (or isomer). Without being bound to theory, it is believed that the amino acid serine is at least one of the tethering agents connecting impurities to the resin. It is believed that the tethering agents should be removed in the rejuvenation process. An amino acid analysis test, for example, an HPLC test, may be used to confirm that the tethering agents have been removed.

Those skilled in the art should appreciate that the parameters and configurations described herein are exemplary and that actual parameters and/or configurations will depend on the specific application in which the disclosed systems and techniques are used. Those skilled in the art should also recognize or be able to ascertain, using no more than routine experimentation, equivalents to the specific embodiments disclosed. For example, those skilled in the art may recognize that the system, and components thereof, according to the present disclosure may further comprise a network or systems or be a component of an ion exchange resin rejuvenation system. It is therefore to be understood that the embodiments described herein are presented by way of example only and that, within the scope of the appended claims and equivalents thereto; the disclosed embodiments may be practiced otherwise than as specifically described. The present systems and methods are directed to each individual feature, system, or method described herein. In addition, any combination of two or more such features, systems, or methods, if such features, systems, or methods are not mutually inconsistent, is included within the scope of the present disclosure. The steps of the methods disclosed herein may be performed in the order illustrated or in alternate orders and the methods may include additional or alternative acts or may be performed with one or more of the illustrated acts omitted.

Further, it is to be appreciated that various alterations, modifications, and improvements will readily occur to those skilled in the art. Such alterations, modifications, and improvements are intended to be part of this disclosure, and are intended to be within the spirit and scope of the disclosure. In other instances, an existing facility may be modified to utilize or incorporate any one or more aspects of the methods and systems described herein. Thus, in some instances, the systems may involve connecting or configuring an existing facility to comprise an ion exchange resin rejuvenation system or components of an ion exchange resin rejuvenation system. Accordingly the foregoing description and figures are by way of example only. Further the depictions in the figures do not limit the disclosures to the particularly illustrated representations.

The phraseology and terminology used herein is for the purpose of description and should not be regarded as limiting. As used herein, the term “plurality” refers to two or more items or components. The terms “comprising,” “including,” “carrying,” “having,” “containing,” and “involving,” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of’ and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

While exemplary embodiments of the disclosure have been disclosed, many modifications, additions, and deletions may be made therein without departing from the spirit and scope of the disclosure and its equivalents, as set forth in the following claims.

1.-13. (canceled)

14. A method of rejuvenating ion exchange resin, the method comprising:
treating an ion exchange resin contaminated with a protein layer with a first cleaning solution including an enzyme to provide a stripped ion exchange resin and protein fragments.

15. The method of claim 14, wherein treating the ion exchange resin with the first cleaning solution includes treating the ion exchange resin with a protease.

16. The method of claim 15, wherein treating the ion exchange resin with the first cleaning solution includes treating the ion exchange resin with subtilisin.

17. The method of claim 14, wherein treating the ion exchange resin with the first cleaning solution includes treating the ion exchange resin with the first cleaning solution at a temperature of about 55° C.

18. The method of claim 14, wherein treating the ion exchange resin with the first cleaning solution includes treating the ion exchange resin with the first cleaning solution at a pH of about 9.

19. The method of claim 14, further comprising backwashing the protein fragments.

20. The method of claim 14, further comprising treating the stripped ion exchange resin with a second cleaning solution to provide a cleaned ion exchange resin.

21. The method of claim 20, wherein treating the stripped ion exchange resin with the second cleaning solution comprises treating the stripped ion exchange resin with an acid.

22. The method of claim 20, wherein treating the stripped ion exchange resin with the second cleaning solution includes treating the stripped ion exchange resin with at least one of a caustic solution, a base solution, a brine solution, or a mixture thereof.

23. The method of claim 20, further comprising rinsing the cleaned ion exchange resin to provide a rinsed ion exchange resin.

24. The method of claim 23, wherein rinsing the cleaned ion exchange resin comprises rinsing the cleaned ion exchange resin with deionized water.

25. The method of claim 23, wherein rinsing the cleaned ion exchange resin comprises rinsing the cleaned ion exchange resin with an acid.

26. The method of claim 23, further comprising exposing the rinsed ion exchange resin to an ionic solution to produce a regenerated ion exchange resin.

27. The method of claim 26, wherein the ionic solution comprises an acid.

28. The method of claim 26, wherein exposing the rinsed ion exchange resin to an ionic solution comprises exposing the rinsed ion exchange resin to a base.

29. The method of claim 14, wherein treating the ion exchange resin comprises treating anion exchange resin.

30. The method of claim 14, wherein treating the ion exchange resin comprises treating cation exchange resin.

31. The method of claim 14 wherein treating the ion exchange resin comprises treating a gel type ion exchange resin.

32. The method of claim 14, wherein treating the ion exchange resin comprises treating a macroporous ion exchange resin.
